(19) United States
(12) Patent Application Publication
(10) Pub. No.: US 2007/0150870 A1
(43) Pub. Date: Jun. 28, 2007

(54) Method and apparatus for context oriented computer program tracing and visualization

(75) Inventors: Blake G. Fitch, White Plains, NY (US); Robert S. Germain, Larchmont, NY (US); Thomas James Christopher Ward, Romsey (GB); Aleksandr Rayshubskiy, Tarrytown, NY (US)

Correspondence Address: MICHAEL J. BUCHENHORNER, 8540 S.W. 83 STREET, MIAMI, FL, 33143, US

(73) Assignee: International Business Machines Corporation

(21) Appl. No.: 11/316,186

(22) Filed: Dec. 22, 2005

(51) Int. Cl. G06F 9/44

(52) U.S. Cl. 717/128

(57) ABSTRACT

A computer-implemented method for collecting trace streams in application code, instruments the application code to detect an application context. The application context includes static and dynamic attributes. The method also includes steps of: achieving the application context a first time, collecting static attributes of the application context, determining a name for the application context based on static attributes, sending the application context name to the trace subsystem and receiving a trace stream handle in return, storing the trace-stream handle and marking the application context such that achieving the same application context later in the program execution is recognizable, receiving the application context name by the trace subsystem, registering the context name in the trace subsystem, returning from the trace subsystem a unique trace stream handle for each unique application context, achieving the instrumented application context after the first time including access to stored trace stream handle, sending dynamic information and the trace stream handle of the application context to the trace subsystem, sending the application context names and associated sequence of dynamic information to trace analysis tools, and receiving the application context names and associated sequence of dynamic information in a trace analysis tool.

### FIELD OF THE INVENTION

The invention disclosed broadly relates to the field of information processing systems, and more particularly relates to a method and system for instrumenting software.

### BACKGROUND OF THE INVENTION

Trace methodologies record information about significant points, or events, during execution of a program. An event record generally comprises a timestamp, the identifier for the central processing unit, and the event type. An event trace is a sequence of event records sorted by time. Computer application software, particularly that created for multithreaded and parallel environments, often overwhelms, or is inhibited, by the intrusive overhead of standard program trace-methodologies. There thus is a need for tracing of a large number of contexts with minimum overhead.

### SUMMARY OF THE INVENTION

Briefly, according to an embodiment of the invention a computer-implemented method for collecting trace streams in application code, instrumenting the application code to detect an application context wherein the application context comprises static and dynamic attributes, achieving the application context a first time, collecting static attributes of the application context, determining a name for the application context based on static attributes, sending the application context name to the trace subsystem and receiving a trace stream handle in return, storing the trace-stream handle and marking the application context such that achieving the same application context later in the program execution is recognizable, receiving the application context name by the trace subsystem, registering the context name in the trace subsystem, returning from the trace subsystem a unique trace stream handle for each unique application context, achieving the instrumented application context after the first time including access to stored trace stream handle, sending dynamic information and the trace stream handle of the application context to the trace subsystem, sending the application context names and associated sequence of dynamic information to trace analysis tools, and receiving the application context names and associated sequence of dynamic information in a trace analysis tool. In other embodiments an information processing system comprises a processor, an input/output subsystem, and a memory that comprises program code for performing the above method. In yet another embodiment a computer-readable medium such as computer memory comprises program code for performing the above method.

### BRIEF DESCRIPTION OF THE DRAWINGS

FIGS. 1A and 1B show a flowchart of a method for visualizing trace streams according to an embodiment of the invention.

FIG. 2 is a high level block diagram showing a visualizer system according to another embodiment of the invention.

FIG. 3 shows a plot of elapsed time versus node count.

FIG. 4 shows a visualization of a trace stream.

### DETAILED DESCRIPTION

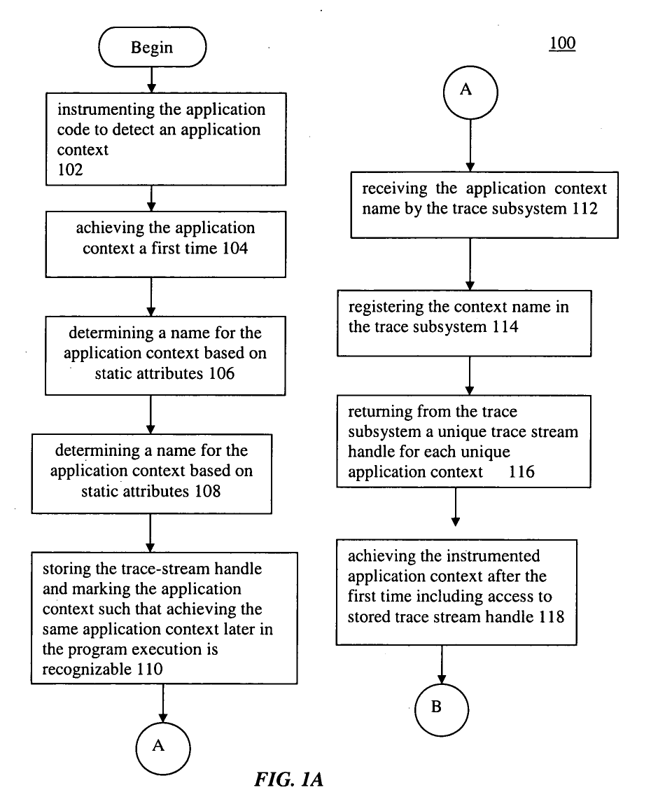

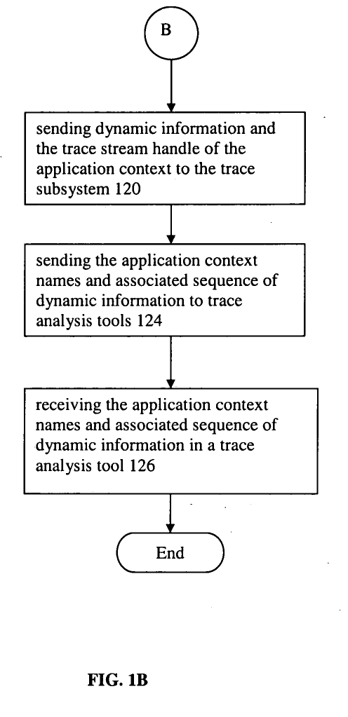

Referring to FIG. 1, there is shown a flow chart illustrating a method 100 for visualizing trace streams in program code according to an embodiment of the invention. The method 100 comprises a step 102 of instrumenting the application code to detect an application context wherein the application context comprises static and dynamic attributes. The program can be stored in system memory from which the description of the contexts may be received for processing.

In step 104 we achieve the application context a first time. A context description can be originally provided by a programmer writing source code for a program. In the first encounter we collect both types of information. According to another embodiment, there are three types of data collected: automatically collected static data; user defined values; and analysis related data. Examples of dynamic information include a timestamp and start and finish points for a context.

Step 106 collects static attributes of the application context. Static attributes do not change and hence can be stored and used in subsequent encounters with the context.

In step 108 we determine a name for the application context based on the static attributes (i.e., information) and whether that name has been fully registered. Next, in step 110 we send the application context name to the trace subsystem and receive a trace stream handle in return. Step 110 stores the trace-stream handle and marks the application context such that achieving the same application context later in the program execution is recognizable.

In step 112 the trace subsystem receives the application context name. Step 114 registers the context name in the trace subsystem. Step 116 returns from the trace subsystem a unique trace stream handle for each unique application context.

Step 118 achieves the instrumented application context after the first time and includes access to stored trace stream handle. as the instrumented context is passed in subsequent executions one determines whether the name is registered and if so the static information can be retrieved. On subsequent executions only the dynamic information is collected. Thus the first execution is slower than subsequent executions due to the greater amount of information collected the first time. We create and record a handle (in a trace file) for the static information such that the static information can be reached. We do this by trading a fully qualified name for the static information for a handle.

Step 120 sends dynamic information and the trace stream handle of the application context to the trace subsystem. Step 122 sends the application context names and associated sequence of dynamic information to trace analysis tools. Step 124 sends the application context names and associated sequence of dynamic information in a trace analysis tool.

Step 126 receives the application context names and associated sequence of dynamic information in a trace analysis tool.

The context is defined in detail by the application programmer forming a “trace stream name.” However, since the application may exist in a programming environment that is designed to create a multitude of similar contexts, such as a multithreaded or parallel environment, the trace infrastructure may automatically add thread or node identifiers to the stream name. An example of this is for the trace system to add process and thread identifiers, or IDs, to the name; so “BeforeReadFromFile” may have converted to “2:3:BeforeReadFromTraceFile” meaning that context in process 2 thread 3.

In an example of a trace stream created for “BeforeReadFromFile,” it would be common for an application programmer to also create a trace stream named “AfterReadFromFile” for the obvious context that occurs when the call to read from a file returns. If this same source code is run on three threads in two processors then you would collect twelve trace streams:

0:0:BeforeReadFromFile

0:1: BeforeReadFromFile

0:2:BeforeReadFromFile

1:0:BeforeReadFromFile

1:1:BeforeReadFromFile

1:2:BeforeReadFromFile

0:0:AfterReadFromFile

0:1:AfterReadFromFile

0:2:AfterReadFromFile

1:0:AfterReadFromFile

1:1:AfterReadFromFile

1:2:AfterReadFromFile

In this embodiment, a visualizer depends heavily on organization of the trace streams by their names. In the simplest case, the visualizer sorts the trace streams alphabetically by name. In order to create groups for display, the visualizer uses regular expression processing (see regexp( ) system call) to select subsets of trace streams. This allows selecting, all of the BeforeReadFromFile trace streams by using the regexp “*BeforeReadFromFile”. Because these streams were selected from the alphabetized list, they will be in process, thread order. This group is then plotted on a time graph by the visualizer tool.

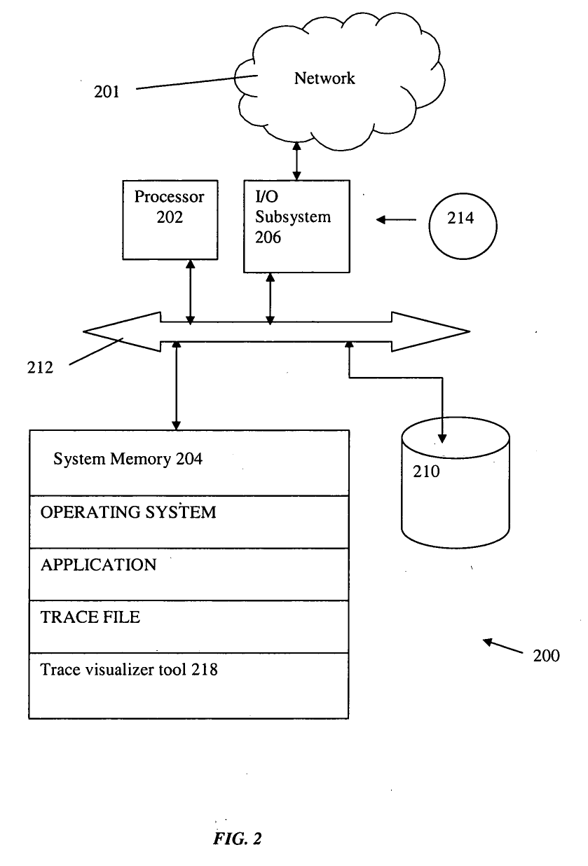

Referring to FIG. 2, we show a computer system 200 used as a trace stream visualizer according to an embodiment of the invention. The system 200 comprises a processor 202, a system memory (e.g., a dynamic random access memory or DRAM), an input/output subsystem 206; and a mass storage device (e.g., a hard disk drive) 210. The components are all coupled together by a bus 212. The memory 204 includes an operating system, one or more application programs and a trace file. The I/O subsystem 206 couples the system 100 to other computers via a network 201 and includes a drive for removable media such as a CD ROM 214. Those skilled in the art will appreciate that the block diagram is highly simplified and may include other or alternative hardware and software.

The processor 202 may comprise one or more microprocessors configured (e.g., programmed) to operate as a visualizer by reading and executing instructions from a visualizer program (or tool) 218. In this case the visualizer is a tool stored in the memory 204.

The interface 206 is any type of communication interface suitable for receiving a description of an application context. For example, the interface can be an interface to an external storage device such as hard disk drive array or to a network such as the internet where other processing or storage resources can be accessed. The second interface can be use for presenting a representation of the trace stream and it can either be a display or a driver for providing signals to a display. The I/O subsystem 206 may comprise various end user interfaces such as a display, a keyboards, and a mouse. The I/O subsystem 206 may further comprise a connection or interface to a network such as a local-area network (LAN) or wide-area network (WAN) such as the Internet 201.

The visualizer system 200 supports several forms of plotting and statistical analysis. For example, in the case where there are BeforeReadFromFile trace streams and AfterReadFromTraceFile trace streams, it would be common to plot a line that starts at a timestamp in the BeforeReadFromFile and ends when the corresponding timestamp in AfterReadFromFile is reached. Because this is so common, the visualizer system 200 will automatically edit the *BeforeReadFromFile trace line set with the *AfterReadFromFile set so that all reads may be plotted on the visualizer timeline.

The visualizer system 200 provides an assortment of tools to zoom and pan on the plotted traces. The system 200 works by providing a user library to instrument the program in the source code environment. This library may write the trace streams to a trace file or send them across a network to a process which creates a trace file. The trace file contains a set of trace stream names each with its own sequence of timestamps. The visualizer 218 is a stand alone program which reads the trace file and manages the organization and display of the data using sorting, regular expressions, as well as custom data structures to provide rapid access to the trace stream data.

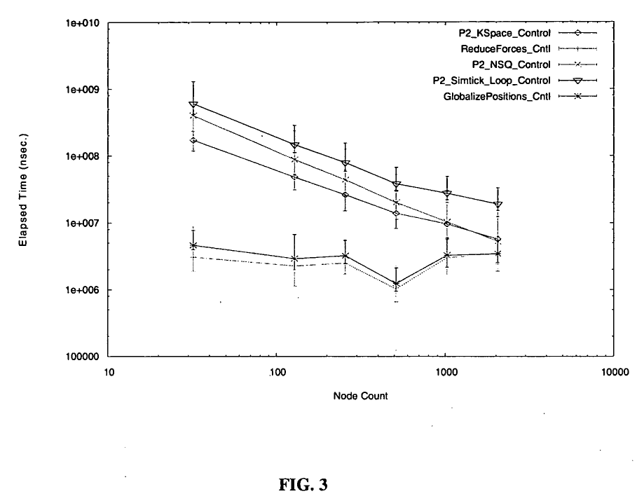

FIG. 3 shows a plot of elapsed time versus node count.

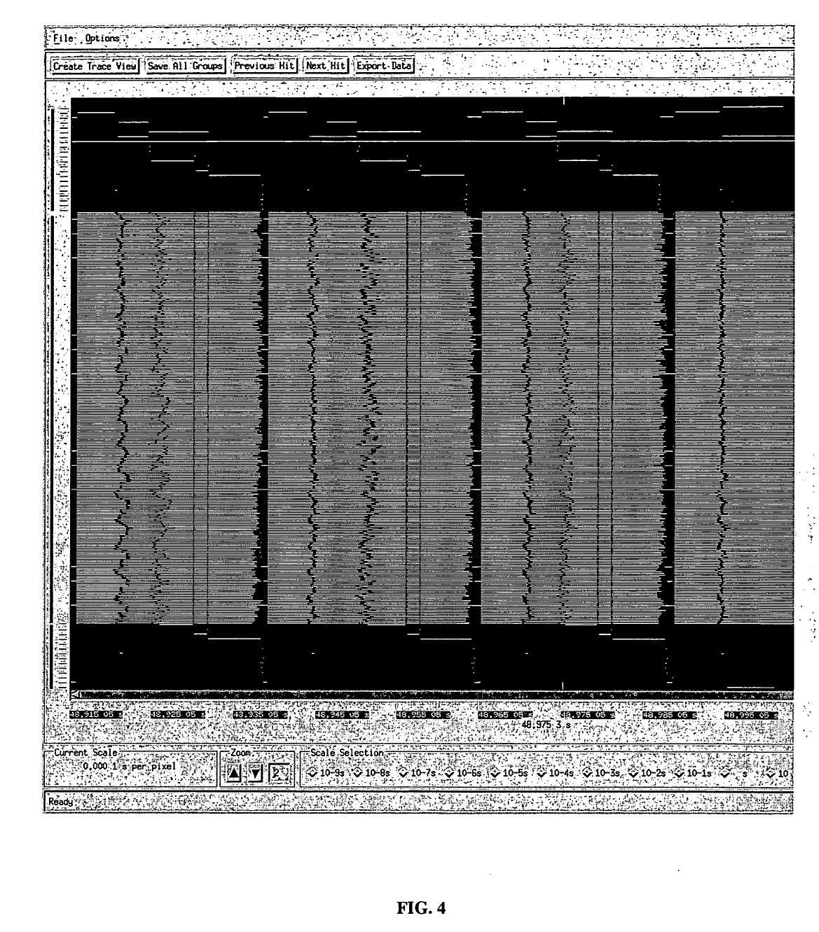

FIG. 4 shows a visualization of a trace stream.

Those skilled in the art will appreciate that other low-level components and connections are required in any practical application of a computer apparatus.

We claim:

1. A computer-implemented method for collecting trace streams in application code, the method comprising:
instrumenting the application code to detect an application context wherein the application context comprises static and dynamic attributes;
achieving the application context a first time;
determining a name for the application context based on static attributes;
determining a name for the application context based on static attributes;
storing the trace-stream handle and marking the application context such that achieving the same application context later in the program execution is recognizable;
receiving the application context name by the trace subsystem;
registering the context name in the trace subsystem;
returning from the trace subsystem a unique trace stream handle for each unique application context;
achieving the instrumented application context after the first time including access to stored trace stream handle;
sending dynamic information and the trace stream handle of the application context to the trace subsystem;
sending the application context names and associated sequence of dynamic information to trace analysis tools;
receiving the application context names and associated sequence of dynamic information in a trace analysis tool.

2. The method of claim 1, further comprising creating a trace stream with the attributes collected.

3. The method of claim 1, further comprising receiving a description of the application.

4. The method of claim 1, further comprising receiving a name for the application context.

5. The method of claim 1 further comprising forming a trace stream name.

6. The method of claim 1 further comprising a step of writing the trace stream to a trace file.

7. The method of claim 5 further comprising a step of adding thread identifiers to the trace stream name.

8. The method of claim 5 further comprising a step of adding node identifiers to the trace stream name.

9. The method of claim 6 further comprising a step of adding process identifiers to the name.

10. The method of claim 5 further comprising a step of sorting trace streams alphabetically by name.

11. The method of claim 5 further comprising a step of using expression processing for selecting subsets of trace streams.

12. The method of claim 5 further comprising a step of plotting each group on a time graph.

13. The method of claim 5 further comprising a step of providing a user library to instrument the program in source code.

14. A computer system comprising a processor, a memory, and an input output subsystem; wherein the memory comprises program code instrumented to for:
wherein the memory comprises an application program instrumented to detect an application context, comprising static and dynamic attributes code, and program code configured for:
achieving the application context a first time;
collecting static attributes of the application context;
determining a name for the application context based on static attributes;
sending the application context name to the trace subsystem and receiving a trace stream handle in return;
storing the trace-stream handle and marking the application context such that achieving the same application context later in the program execution is recognizable
receiving the application context name by the trace subsystem;
registering the context name in the trace subsystem;
returning from the trace subsystem a unique trace stream handle for each unique application context;
achieving the instrumented application context after the first time including access to stored trace stream handle; sending dynamic information and the trace stream handle of the application context to the trace subsystem;
sending the application context names and associated sequence of dynamic information to trace analysis tools;
receiving the application context names and associated sequence of dynamic information in a trace analysis tool.

15. The system of claim 14 further comprising memory space for storing the description of the application.

16. The system of claim 14 wherein the input/output subsystem comprises a display.

17. The system of claim 14 wherein the input/output subsystem comprises a network interface.

18. The system of claim 14 wherein the input/output subsystem comprises a display driver for producing signals for driving the display to show a trace stream.

19. The system of claim 1, further comprising an interface for receiving a description of an application context.

20. A computer readable medium comprising program code for:
instrumenting the application code to detect an application context wherein the application context comprises static and dynamic attributes;
achieving the application context a first time;
collecting static attributes of the application context;
determining a name for the application context based on static attributes;
sending the application context name to the trace subsystem and receiving a trace stream handle in return;
storing the trace-stream handle and marking the application context such that achieving the same application context later in the program execution is recognizable
receiving the application context name by the trace subsystem;
registering the context name in the trace subsystem;
returning from the trace subsystem a unique trace stream handle for each unique application context;
achieving the instrumented application context after the first time including access to stored trace stream handle;
sending dynamic information and the trace stream handle of the application context to the trace subsystem;
sending the application context names and associated sequence of dynamic information to trace analysis tools;
receiving the application context names and associated sequence of dynamic information in a trace analysis tool.
